(19) United States
(12) Patent Application Publication
(10) Pub. No.: US 2017/0114986 A1
(43) Pub. Date: Apr. 27, 2017

(54) LUMINAIRES

(71) Applicant: SCHREDER SA, BRUSSELS (BE)

(72) Inventors: STÉPHANE GIROUARD, JUPILLE-SUR-MEUSE (BE); YVES COMHAIRE, NEUPRÉ (BE)

(73) Assignee: SCHREDER SA

(21) Appl. No.: 15/298,805

(22) Filed: Oct. 20, 2016

(30) Foreign Application Priority Data
Oct. 26, 2015 (BE) 2015/5688

(51) Int. Cl. F21V 17/10; F21V 31/00; H05B 33/08; F21V 17/16; F21V 3/00; F21S 8/08; F21V 23/06

(52) U.S. Cl. CPC F21V 17/107; F21S 8/086; F21V 31/005; F21V 23/06; F21V 17/164; F21V 3/00; H05B 33/0887; F21Y 2115/10

(57) ABSTRACT

Described herein is a luminaire which comprises two compartments, a first compartment mountable to a supporting structure and a second compartment mountable to the first compartment. The second compartment includes lighting functionality and the first compartment includes non-lighting functionality such as a camera, a siren and a signalling unit.

### FIELD OF THE INVENTION

The present invention relates improvements in or relating to luminaires and is more particularly concerned with luminaire housings.

### BACKGROUND OF THE INVENTION

Luminaires are well known for providing lighting to both indoor and outdoor areas, in particular, for providing street lighting. Such luminaires conventionally comprise a lighting head mounted on a supporting pole, the lighting head having a housing in which lighting elements are located. With the advance of technology, there is now a trend towards combining lighting functionality with non-lighting functionality, such as, motion detectors, cameras, air pollution sensors and communications units.

US-A-2005/0115802 discloses a luminaire comprising a top body portion and a bottom body portion, the top body portion forming a housing into which the bottom body portion is mounted. The bottom body portion has a plurality of apertures for receiving at least a main lighting module and at least one non-lighting module. The main lighting module emits a broad lighting pattern for lighting a predetermined area, such as, a portion of a road. Secondary lighting modules may be included for providing more directed lighting patterns, for example, for sidewalks and cycle paths. In addition to the lighting modules, non-lighting modules may include motion detectors, cameras, air pollution sensors and communications units. The apertures for receiving the secondary lighting modules and the non-lighting modules are substantially the same size so that they can be interchanges as required.

In the luminaire described in US-A-2005/0115802, as the lighting modules and the non-lighting modules are mounted in the same bottom body portion which is then mounted in a top body portion which is sized to accommodate the bottom body portion, each luminaire effectively comprises a single compartment and there can be no adjustment for more apertures to accommodate more modules without having to replace the entire luminaire. This has the disadvantage that the luminaire cannot readily be adapted to accommodate different numbers of main lighting modules, secondary lighting modules and/or non-lighting modules as the entire luminaire needs to be modified accordingly.

### SUMMARY OF THE INVENTION

It is an object of the present invention to provide a modular luminaire which can readily be adapted for different lighting requirements without having to change the non-lighting modules.

It is another object of the present invention to provide a modular luminaire in which the non-lighting requirements can be adapted without having to change the lighting modules.

It is a further object of the present invention to provide a luminaire having two compartments where one compartment is removably mounted with respect to the other compartment.

In accordance with one aspect of the present invention, there is provided a dual-compartment luminaire comprising:

a first compartment mountable to a supporting structure; and

a second compartment mountable to the first compartment, one of the first and second compartments including lighting functionality and the other of the first and second compartments including non-lighting functionality and each of the first and second compartments being independently optimised in at least shape in accordance with its designated functionality.

By having a luminaire with two compartments which are dedicated to lighting and non-lighting functionality respectively, it is easy to replace the lighting functionality compartment without having to replace the non-lighting functionality compartment in accordance with the requirement for more or less luminous flux in the vicinity of the luminaire. In addition, replacement of a non-functioning lighting functionality compartment can readily be achieved once the luminaire has been installed.

In addition, but having two compartments the size and/or shape can be varied independently, it is possible to integrate required lighting power or luminous flux on one hand with desired non-lighting functions on the other hand.

The dual-compartment luminaire may further comprise mounting means for mounting the second compartment on the first compartment, the mounting means comprising a first mounting interface provided on the first compartment and a second mounting interface formed on the second compartment, the first and second mounting interfaces being complementary to one another and engagement of the first and second mounting interfaces in a first position provides a hinge portion about which the second compartment is rotatable with respect to the first compartment to a second position where the second compartment is fully mounted on the first compartment.

In one embodiment, the dual-compartment luminaire further comprises at least one interface between the first and second compartments.

Said at least one interface may comprise a mechanical interface joining the two compartments together in the second position. The mechanical interface may comprise a first portion formed in the first compartment and a second portion formed in the second compartment, the first and second portions being complementary and engagement thereof provides the seal between the two compartments in the second position.

By having such a mechanical interface, the components within each of the first and second compartments can be protected from environmental conditions, such as, rain, moisture, dust, dirt etc.

In one embodiment, the first portion comprise a lip and the second portion comprises first and second ribs which are spaced from one another to define a space into which the lip of the first portion engages.

A seal or gasket may be located in the space between the first and second ribs. In this embodiment, the lip of the first portion is configured to deform one of: the seal and gasket in the space to seal against the first and second ribs.

Said at least one interface further comprises an electrical connection providing electrical power from one compartment to the other.

The electrical connection preferably comprises a first connector mounted in the first compartment and a second connector mounted in the second compartment, the first and second connectors being aligned so that, in the second position, together they form the electrical connection.

In one embodiment, the first compartment comprises at least one first clip portion formed in a peripheral portion thereof and the second compartment comprises at least one second clip portion formed in a peripheral portion thereof, the clip portions being formed at locations in each peripheral portion of the first and second compartments so as to be aligned in the second position and each clip first portion of the first compartment being complementary to an associated second clip portion of the second compartment.

The clip portions have the advantage of providing a quick and easy connection between the two compartments so that the compartments can readily be replaced or upgraded as required.

In one embodiment, the first compartment comprises a non-lighting functionality compartment and the second compartment comprises a lighting functionality compartment.

This has the advantage that the second compartment may readily be replaced in accordance with lighting requirements without having to replace the non-lighting functionality.

The lighting functionality compartment comprises a first part which is mountable on the non-lighting functionality compartment and a second part extending from the first part, the second part including at least a lighting window and at least one lighting elements.

The non-lighting functionality of the first compartment may comprises at least one of: a siren, a camera and a signalling unit.

This has the advantage that more than one non-lighting function can be accommodated within the first compartment and the number of non-lighting functions can readily be customised in accordance with a particular implementation of the dual-compartment luminaire.

### BRIEF DESCRIPTION OF THE DRAWINGS

For a better understanding of the present invention, reference will now be made, by way of example, to the accompanying drawings in which:—

FIGS. 1a, 1b and 1c respectively illustrate side views of first, second and third embodiments of dual-compartment luminaires in accordance with the present invention;

FIG. 2 illustrates a perspective view of a first compartment of the dual-compartment luminaires of FIGS. 1a, 1b and 1c from above;

FIG. 3 illustrates a perspective view of the first compartment of FIG. 2 from below;

FIG. 4 illustrates a perspective view of a second compartment of the dual-compartment luminaire of FIG. 1a from below;

FIG. 5 illustrates a perspective view of the partly assembled dual-compartment luminaire of FIG. 1a from above;

FIG. 6 illustrates a perspective view of the assembled dual-compartment luminaire of FIG. 1a from below; and

FIG. 7 illustrates a perspective view of the assembled dual-compartment luminaire of FIG. 1a.

### DESCRIPTION OF THE INVENTION

The present invention will be described with respect to particular embodiments and with reference to certain drawings but the invention is not limited thereto. The drawings described are only schematic and are non-limiting. In the drawings, the size of some of the elements may be exaggerated and not drawn on scale for illustrative purposes.

When trying to include non-lighting functionality into luminaires, several components need to be added into the luminaire casing or housing. As a result, the internal volume of the casing or housing needs to be increased which creates a need for a specific casing or housing in accordance with particular non-lighting functionality. In accordance with the present invention, non-lighting functionality can readily be incorporated into a luminaire casing or housing which comprises two separate and independent compartments, one for lighting functionality and one for non-lighting functionality.

A first compartment includes non-lighting functionality and its dimensions can be adapted to the functions that need to be included therein, for example, cameras, signalling lights (flashing lights), sensors, sirens, loudspeakers etc.

In the specific embodiments of the invention described below, the non-lighting functionality may include a camera, a siren and a flashing light, and, the first compartment is shaped to accommodate these non-lighting functionalities which need to extend through one of the compartment walls. It will readily be appreciated that the compartment walls may include other apertures into which other non-lighting functionality is located. In each case, the non-lighting functionality is effectively sealed with respect to the compartment wall to prevent the ingress of water, dirt and other pollutants into the luminaire from the surrounding environment.

Although not shown, other non-lighting functionality can be included which does not need to extend through any of the compartment walls, for example, communications modules, vibration sensors etc. Naturally, the shape and volume of the first compartment is chosen to accommodate all desired non-lighting functionality with, in some cases, extra space to incorporate additional non-lighting functionality at a later date.

A second compartment, in which lighting functionality is provided is designed to be mountable on the first compartment in a first position and to be rotated to a second position where the second compartment can easily be fixed onto the first compartment for quick and easy replacement of the second compartment. This enables easy maintenance and replacement of components relating to lighting functionality, for example, light engine, lighting element etc., without needing to access non-lighting related functions.

The second compartment comprises two parts: a first part which is mountable on the first compartment and a second part in which a lighting window is provided in which at least one lighting element is located. The first part is sized to match with the first compartment, and, the second part may have any suitable shape and/or size to produce the required luminous flux for the area to be illuminated by the luminaire.

Whilst the first compartment and second compartments have been described above as housing non-lighting functionality and lighting functionality respectively, it will readily be appreciated that, in other embodiments, the first compartment may comprise the lighting functionality and the second compartment may comprise the non-lighting functionality.

Typically, the first compartment, irrespective of whether it houses non-lighting or lighting functionality, is mounted to a pole or other support for the luminaire in accordance with the present invention and the second compartment, housing another functionality to that of the first compartment, is snapped onto the first compartment.

The interface between the first and second compartments is mostly mechanical having a common surface where the two parts are assembled and snapped together. The interface is also electrical with the use of a direct connector that connects the two compartments to one another so that a mains supply and other control signals can be provided from one compartment to the other compartment.

This easy connection provides a very quick and simple assembly and dis-assembly (or removal) of one compartment with respect to the other and facilitates maintenance or replacements.

The term “dual-compartment luminaire” as used herein refers to a luminaire having a lighting functionality compartment and a non-lighting functionality compartment which are mounted to one another. The lighting functionality compartment includes a lighting window which extends beyond the non-functionality compartment and which provides lighting or luminous flux in the vicinity of the luminaire.

The term “lighting functionality compartment” as used herein refers to a compartment which houses at least one light engine comprising at least one lighting element, preferably an array of light-emitting diodes or the like, and a driver for driving each lighting element such as the array or the like. There may be a single main light engine which provide general illumination to a selected area or a main light engine with subsidiary (complementary) light engines for illuminating specific areas in addition to general illumination. As described above, a lighting window extends from the lighting functionality compartment to provide lighting in the vicinity of the luminaire. As will be described below, the “lighting functionality compartment” comprises a first part and a second part, the first part engaging with the non-lighting functionality compartment and housing components for powering and driving at least one lighting element housed in the second part. The second part comprises the lighting window.

The term “non-lighting functionality compartment” as used herein refers to a compartment which houses components which are not lighting-related as described above. Typically, the non-lighting functionality compartment does not obscure the lighting window associated with the lighting functionality compartment.

The terms “pole” or “support” as used herein refer to any suitable means of mounting a dual-compartment luminaire in accordance with the present invention. The term “pole” usually refers to a substantially vertical structure with the luminaire being mounted at the top thereof. The term “support” may include a pole but may also include other structures for mounting a luminaire which are not substantially vertical.

The term “supporting structure” as used herein refers any structure capable of supporting a luminaire mounted thereto.

Components or elements which are identical in each of the Figures are labelled the same. Components or elements which are similar to others previously described are labelled the same but with a different suffix, for example, “A”, “B”, “C” etc.

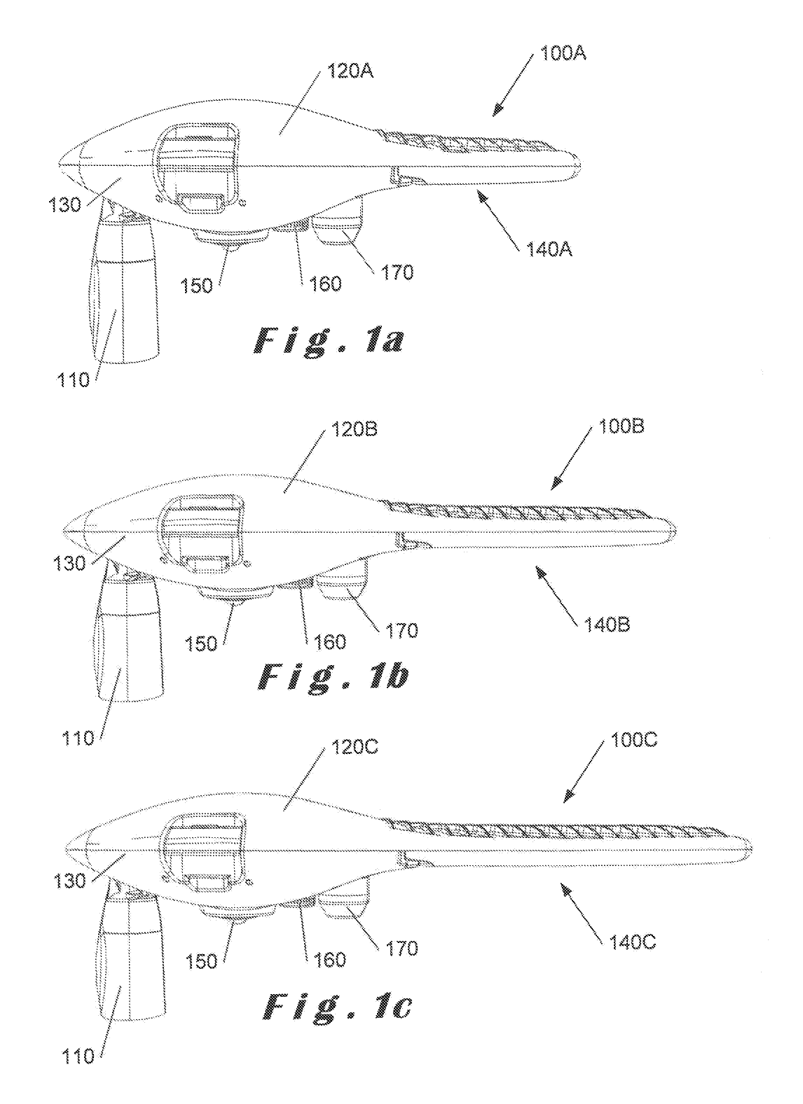

Referring now to FIG. 1a, a luminaire 100A is shown mounted on a pole or support 110. In accordance with the present invention, the luminaire 100A comprises a first (or lighting functionality) compartment 120A and a second (or non-lighting functionality) compartment 130. In this embodiment, the second compartment 130 comprises non-lighting functionality and is mounted to the pole or support 110.

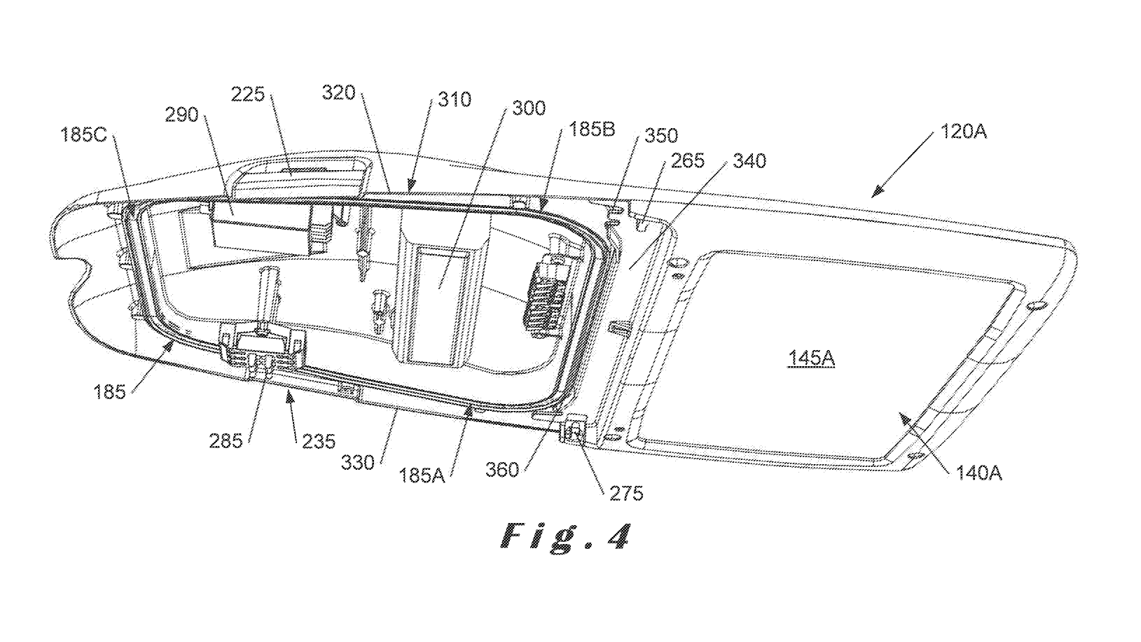

The first compartment 120A comprises lighting functionality 140A and which is mounted on top of the second compartment 130 as shown. Lighting functionality 140A includes a luminaire light engine (not shown) which drives one or more lighting elements, for example, light-emitting diode (LED) arrays, to provide light which passes through a lighting window 145A (as shown more clearly in FIG. 4).

The second compartment 130 is shaped to accommodate a camera module 150, a siren module 160 and a signalling or flashing light module 170. Other modules may also be included (not shown) which provide other non-lighting functionality and which are not required to extend outside of the luminaire casing or housing formed by the first and second compartments 120A, 130. For example, sensors for air quality, temperature and/or humidity may be provided which sample air from outside of the luminaire.

The connection or joining of the first compartment 120A to the second compartment 130 will be described in more detail below.

FIG. 1b illustrates a luminaire 100B which is similar to the luminaire 100A shown in FIG. 1a. In this embodiment, first compartment 120B is larger than first compartment 120A with a larger lighting functionality 140B including a lighting window having a larger area for illuminating a greater area than the lighting window 145A of the first compartment 120A. In this case, the luminaire 100B may provide light over a larger area than luminaire 100A due to its larger lighting window.

Similarly, FIG. 1c illustrates a luminaire 100C which comprises a first compartment 120C which is even larger than first compartment 120B with an ever larger lighting functionality 140C including a lighting window having an even larger area than lighting window 145A of the first compartment 120A. Luminaire 100C may provide light over a larger area than either one of luminaire 100A and luminaire 100B.

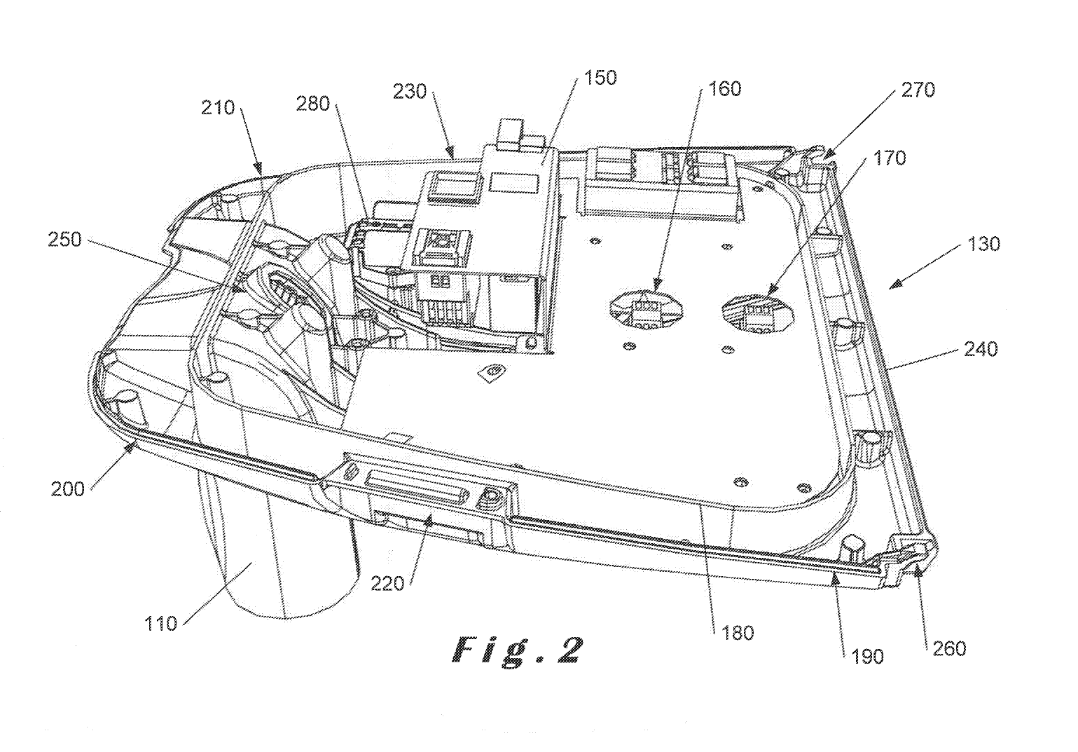

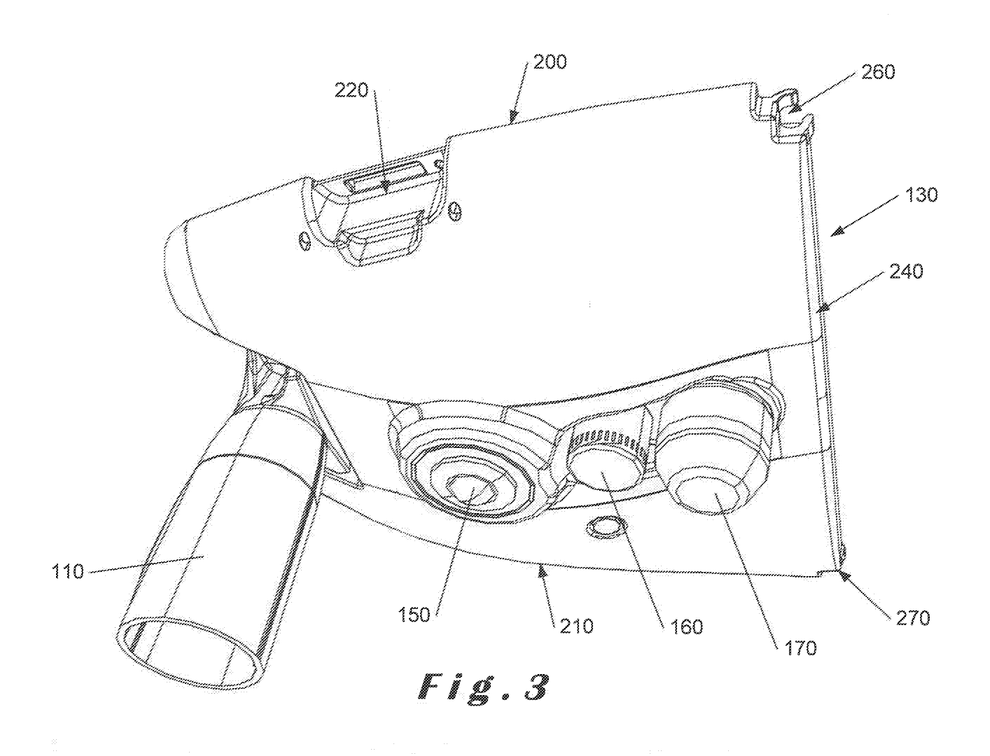

FIGS. 2 and 3 illustrate perspective views of the second compartment 130 from above and below respectively when the first compartment 120A (or 120B or 120C) is not attached. As described above, the camera module 150, the siren module 160 and the signalling or flashing light module 170 are shown. A lip 180 is provided which extends around the second compartment 130 and which engages with a corresponding portion 185 of the first compartment 120A as shown in FIG. 4. The corresponding portion 185 will be described in more detail below with reference to FIG. 4.

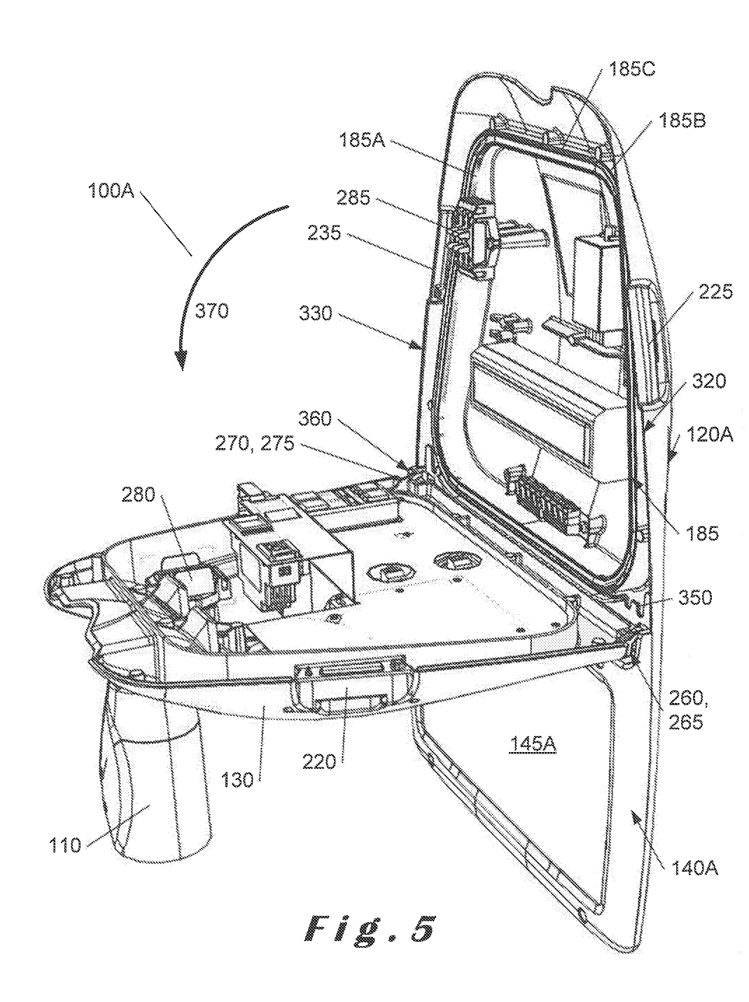

The second compartment 130 includes a peripheral edge 190 which comprises peripheral edge portions 200, 210 in which respective snap clip portions 220, 230 are located. Snap clip portions 220, 230 engage with corresponding snap clip portions 225, 235 formed in the first compartment 120A as shown in FIG. 5 to form respective snap clip connectors.

Although the connectors for connecting the second compartment 130 to the first compartment 120A (or 120B or 120C) have been described as being snap clip connectors, it will readily be appreciated that any other suitable “quick fix” connector can be used with provides easy and rapid connection and disconnection of the two compartments for the exchange of lighting compartments and/or to provide access to non-lighting functions to install, replace and update such functions.

A substantially straight peripheral edge portion 240 is provided at a location remote from mounting point 250 at which the second compartment 130 is mounted on the pole or support 110. The peripheral edge portion 240 has hook portions 260, 270 located at each end thereof, the hook portions 260, 270 engaging with corresponding pins 265, 275 formed in the first compartment 120A as shown in FIG. 5.

An electrical connector 280 is also provided in the second compartment 130 for providing electrical connections to the first compartment 120A via a corresponding electrical connector 285 provided therein. The electrical connector 280 and corresponding electrical connector 285 are positioned within their respective compartments so that they are automatically engaged when the two compartments are mounted to one another.

Turning now to FIG. 4, a perspective view of a first compartment 120A from below is shown in more detail. As shown, the first compartment 120A comprises a first part which relates to providing power to for lighting functions and a second part which relates to providing the lighting functions. The first part forms the part of the compartment 120A which engages with the second compartment 130 as will be described in more detail below.

In the first part, a surge protection module or circuit 290 is provided which is connected between the electrical connector 285 and a power source 300, the power source providing power to lighting elements within the first part or the lighting functionality 140A. Other components may be provided (not shown in detail) which are required for the operation of the lighting functionality 140A.

In the second part, as described above, lighting functionality 140A is provided which includes a lighting window 145A through which light passes to illuminate a designated area associated with the positioning of the luminaire. Such a part may comprise a plurality of lighting elements, for example, at least one light-emitting diode (LED) array, and at least one light engine for driving each LED array. It will be appreciated that the light engine(s) may be housed within the first part of the compartment 120A and be connected to the LED array(s) by means of wires passing through a common wall connecting the two parts.

In a similar way to the second compartment 130, the first compartment 120A has a peripheral edge 310 which comprises peripheral edge portions 320, 330 which extend from the second part providing the lighting functionality 140A. Peripheral edge portion 320 includes the corresponding clip portion 225 which snaps together with clip portion 220 in peripheral edge portion 200 of the second compartment 130 and peripheral edge portion 330 includes the corresponding clip portion 235 which snaps together with clip portion 230 in peripheral edge portion 210 of the second compartment 130. As described above, the corresponding clip portions are designed to engage with one another to form snap clip connectors.

The first compartment 120A includes a recess 340 between the lighting functionality 140A and the second part providing power to the lighting functionality 140A. At opposite edges of the recess 340, the pins 265, 275 are formed which engage with respective hook portions 260, 270 when the first compartment 120A is assembled on the second compartment 130. Adjacent the pins 265, 275, slot portions 350, 360 are formed which engage with corresponding portions (not shown) in the second compartment 130.

As described above, the second compartment 130 includes a lip 180 which engages with a corresponding portion 185 of the first compartment 120A. The corresponding portion 185 comprises a mechanical interface into which the lip 180 is engaged when the first and second compartments are assembled together. As shown in FIG. 4, the mechanical interface 185 extends around the first compartment 120A and comprises a first (or inner) rib 185A and a second (or outer) rib 185B which are spaced from one another to define a space 185C which is sufficient to allow the lip 180 of the second compartment 130 to engage therebetween.

A seal or gasket (not shown) is provided in the space 185C between the inner and outer ribs 185A, 185B to ensure that the luminaire 100A is water-tight when fully assembled, the lip 180 of the second compartment deforming the seal or gasket in the space 185C so that the seal or gasket seals against the inner and outer ribs 185A, 185B and the lip 180 itself to effect water-tightness.

As described above with reference to FIGS. 1b and 1c, more lighting may be provided and the power source 300 is adapted accordingly to be able to supply a required output luminous flux in each case. However, in each of the embodiments described above with reference to FIGS. 1a, 1b and 1c, the mechanical interface 185 within the second compartment 130 is the same. This provides flexibility for either increasing or decreasing the output luminous flux by changing the first compartments 120A, 120B, 120C which engage with the second compartment 130.

FIG. 5 illustrates a luminaire 100A during its assembly. The second compartment 130 housing the non-lighting functionality has been mounted on the pole or support 110 and extends substantially perpendicularly thereto (also shown in FIGS. 2 and 3) and lies in a substantially horizontal plane. The first compartment 120A is aligned so that the hook portions 260, 270 on either side of the substantially straight peripheral edge portion 240 engage with respective pins 265, 275 provided in the recess 340 (FIG. 4), the pins forming pivot points (defining a hinge portion) about which the first compartment 120A can rotate with respect to the second compartment 130 in the direction indicated by arrow 370 so that it also lies in a substantially horizontal plane against the second compartment 130.

As shown in FIG. 5, the first compartment 120A is in a first position with respect to the second compartment, that is, the first compartment is angled with respect to the second compartment. Rotation in the direction of arrow 370 causes the first compartment 120A to be rotated from the first position to a second position where the first compartment is substantially aligned with the second compartment 130. The first position of the first compartment 120A is approximately 45 degrees with respect to the second compartment 130.

In a preferred embodiment of the present invention, the first compartment may also be rotated to a third position from either the first and second positions as shown in FIG. 5. In this third position, the first compartment is at approximately 90 degrees with respect to the second compartment to provide easy access for adjustment of the non-lighting functionality without having to demount the first compartment from the second compartment.

In the second position of the first compartment after rotation about the hinge portion defined by the pivot points and with both the first and second compartments substantially lying in adjacent horizontal planes, the electrical connectors 280 in the second compartment 130 and the electrical connector 285 in the first compartment 120A engage with one another so that power can be supplied to the first compartment 120A and the lighting functionality 140A located therein. Engagement of respective snap clip portions 220, 230 (on the second compartment) with snap clip portions 225, 235 (on the first compartment) fixes the first compartment 120A on the second compartment 130.

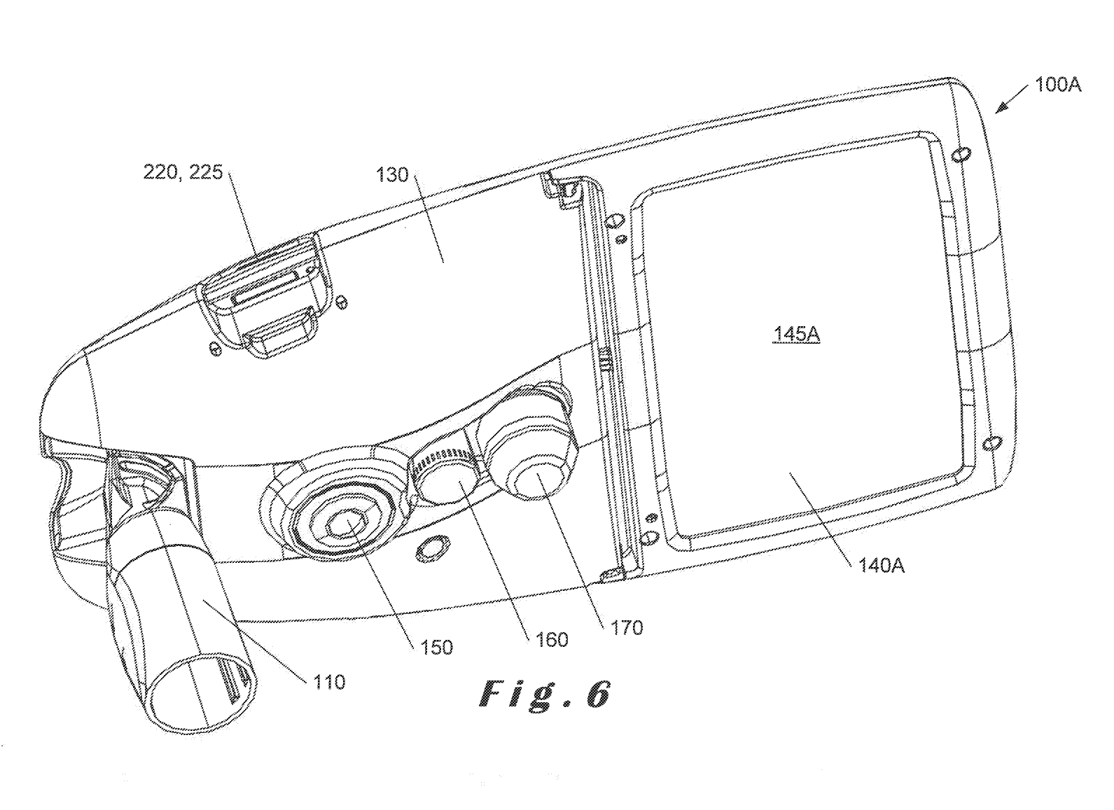

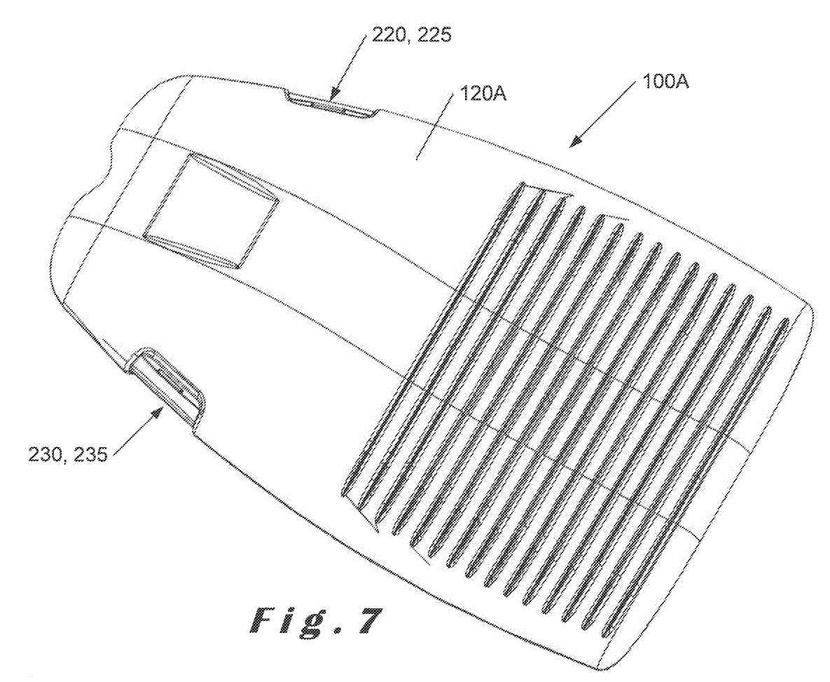

FIGS. 6 and 7 respectively illustrate perspective views of the assembled luminaire 100A from below and from above. It will readily be appreciated that luminaires 100B and 100C are assembled in the same way and will look similar to luminaire 100A apart from size as described above.

Whilst both the lighting functionality compartment and the non-lighting functionality compartment are described as being mounted in a substantially horizontal plane, it will readily be appreciated that these compartments may be mounted in a plane which is angled with respect to a horizontal plane.

As described above, whilst it is possible for either the lighting functionality compartment or on the non-lighting functionality compartment of the luminaire to be mounted to the pole or support, it is preferred that the non-lighting functionality compartment of the luminaire is mounted to the pole or support. The main advantage of mounting the luminaire this way is that the installation can be done in two easy steps.

In a first step, the non-lighting functionality compartment is installed on the pole or support and the connections are made with the incoming power cable within the pole or support. Cables relating to both lighting functionality (often switched off during the day) and non-lighting functionality are connected in the non-lighting functionality compartment. The non-lighting functionality compartment includes the non-lighting functions which are already connected to incoming connectors.

In a second step, the lighting functionality compartment is mounted on the non-lighting functionality compartment and secured by quick snap connections. At the same time, electrical connections necessary for the lighting functionality compartment are automatically made through an easy chassis-to-chassis connector where one part of the connector is located in the non-lighting functionality compartment and the other part of the connector is located in a corresponding location in the lighting functionality compartment.

The advantages of such a dual-compartment luminaire structure are as follows:

1) The system is flexible and can permit individual optimisation of the shape and/or size of the first and second compartments. For example, by having a second compartment or non-lighting functionality compartment of a predetermined size, shape and volume, a first compartment or lighting functionality compartment having a first part that will engage with the second compartment can be used irrespective of the size of the second part associated therewith housing the lighting window and lighting elements as described above. This means that a common first part can be provided for a number of first compartments each of which having differently sized and shaped lighting window which generate different values of luminous flux. This is described above with reference to FIGS. 1a, 1b and 1c.

2) Different combinations of non-lighting functionality compartments and lighting functionality compartments can be provided which can readily be interchanged as required by a particular installation or implementation.

3) The non-lighting functionality compartment can easily be retrofitted into an existing luminaire to provide added functionalities upon request.

4) Aesthetically, by having dual compartments, uniformity of luminaires in a particular location can look the same even though they may have different functionality, namely, some luminaires may be equipped with a non-lighting functionality compartment with components associated therewith whilst other luminaires may look the same and have a compartment (normally a non-lighting functionality compartment) which does not include any non-lighting functionality but with the connectors between the compartments operating the same as described above.

The dual-compartment of a luminaire in accordance with the present invention readily provides non-lighting related functions for an existing luminaire.

Quick and easy replacement of a light engine in a lighting compartment is provided without having to remove components associated with non-lighting functionality and/or the non-lighting functionality compartment itself.

The size, shape and volume of each compartment can be independently optimised irrespective of the other—the only requirement is that the compartments can clip together when assembled.

The dual-compartment luminaire of the present invention, although described above as being mounted to a pole or other support, it will readily be appreciated that other supports are possible, for example, a substantially horizontal support to which one of the compartments is mounted as described above.

Although the dual compartment luminaire of the present invention has been described with respect to specific embodiments, it will readily be appreciated that the present invention is not limited thereto and other embodiments are possible which comprise a lighting functionality compartment and a non-lighting functionality compartment.

1. A dual-compartment luminaire comprising:
a first compartment mountable to a supporting structure;
a second compartment mountable to the first compartment;
one of the first and second compartments including lighting functionality; and
an other one of the first and second compartments including non-lighting functionality, each of the first and second compartments being independently optimised for at least shape in accordance with its designated functionality.

2. A dual-compartment luminaire according to claim 1, further comprising:
mounting means for mounting the second compartment on the first compartment, the mounting means comprising:
a first mounting interface provided on the first compartment; and
a second mounting interface formed on the second compartment, the first and second mounting interfaces being complementary to one another; and
engagement of the first and second mounting interfaces in a first position providing a hinge portion about which the second compartment is rotatable with respect to the first compartment to a second position where the second compartment is fully mounted on the first compartment.

3. A dual-compartment luminaire according to claim 1, further comprising:
at least one interface between the first and second compartments.

4. A dual-compartment luminaire according to claim 3, wherein said at least one interface comprises:
a mechanical interface joining the two compartments together in the second position.

5. A dual-compartment luminaire according to claim 4, wherein the mechanical interface comprises:
a first portion formed in the first compartment; and
a second portion formed in the second compartment, the first and second portions being complementary and engagement thereof provides a seal between the two compartments in the second position.

6. A dual-compartment luminaire according to claim 5, further comprising:
the first portion comprising a lip; and
the second portion comprising first and second ribs which are spaced from one another to define a space into which the lip of the first portion engages.

7. A dual-compartment luminaire according to claim 6, further comprising:
an element located in the space between the first and second ribs that is selected from the group consisting of a seal and a gasket.

8. A dual-compartment luminaire according to claim 7, wherein the lip of the first portion is configured to deform the element located in the space to seal against the first and second ribs.

9. A dual-compartment luminaire according to claim 3, wherein said at least one interface comprises:
an electrical connection providing electrical power from one compartment to the other.

10. A dual-compartment luminaire according to claim 9, wherein the electrical connection comprises:
a first connector mounted in the first compartment; and
a second connector mounted in the second compartment, the first and second connectors being aligned so that, in the second position, together they form the electrical connection.

11. A dual-compartment luminaire according to claim 1, further comprising:
the first compartment comprising at least one first clip portion formed in a peripheral portion thereof; and
the second compartment comprising at least one second clip portion formed in a peripheral portion thereof, the at least one first and second clip portions being formed at locations in each peripheral portion of the first and the second compartments so as to be aligned in the second position and each at least one first clip portion of the first compartment being complementary to an associated second clip portion of the at least one second clip portion of the second compartment.

12. A dual-compartment luminaire according to claim 1, further comprising:
the first compartment comprising a non-lighting functionality compartment; and
the second compartment comprising a lighting functionality compartment.

13. A dual-compartment luminaire according to claim 12, further comprising:
the lighting functionality compartment comprising a first part which is mountable on the non-lighting functionality compartment;
a second part extending from the first part;
the second part comprising at least one lighting window; and
the second part comprising at least one lighting element.

14. A dual-compartment luminaire according to claim 12, wherein the non-lighting functionality of the first compartment comprises:
an additional element that is selected from the group consisting of a siren, a camera and a signalling unit.

15. A dual-compartment luminaire comprising:
a first compartment mountable to a supporting structure;
a second compartment mountable to the first compartment;
one of the first and the second compartments including lighting functionality;
an other one of the first and second compartments including non-lighting functionality, each of the first and second compartments being independently optimised for at least shape in accordance with its designated functionality;
at least one interface between the first and the second compartments;
said at least one interface comprising a mechanical interface;
said mechanical interface comprising a first portion formed in the first compartment; and
said mechanical interface comprising a second portion formed in the second compartment, the first and second portions being complementary and engagement thereof forms a seal between the two compartments.

16. A dual-compartment luminaire according to claim 15, further comprising:
the first portion comprising a lip; and
the second portion comprising first and second ribs which are spaced from one another to define a space into which the lip of the first portion engages.

17. A dual-compartment luminaire according to claim 16, further comprising:
an element located in the space between the first and second ribs that is selected from the group consisting of a seal and a gasket.

18. A dual-compartment luminaire according to claim 17, wherein the lip of the first portion is configured to deform the element located in the space to seal against the first and second ribs.

19. A dual-compartment luminaire according to claim 15, further comprising:
the first compartment comprising at least one first clip portion formed in a peripheral portion thereof; and
the second compartment comprising at least one second clip portion formed in a peripheral portion thereof, the at least one first and second clip portions being formed at locations in each of the peripheral portions of the first and second compartments so as to be aligned in the second position and each at least one first clip portion of the first compartment being complementary to an associated one of the at least one second clip portion of the second compartment.

20. A dual-compartment luminaire according to claim 15, further comprising:
the first compartment comprising a non-lighting functionality compartment;
the second compartment comprising a lighting functionality compartments;
the lighting functionality compartment comprising a first part which is mountable on the non-lighting functionality compartment;
the lighting functionality compartment comprising a second part extending from the first part;
the second part comprising at least a lighting window; and
the second part comprising at least one lighting element.
